(19) United States
(12) Patent Application Publication
(10) Pub. No.: US 2014/0332046 A1
(43) Pub. Date: Nov. 13, 2014

(54) ALKALI METAL THERMAL TO ELECTRIC CONVERTER SYSTEM INCLUDING HEAT EXCHANGER

(71) Applicant: KOREA INSTITUTE OF ENERGY RESEARCH, Daejeon (KR)

(72) Inventors: Sun-Dong KIM, Daejeon (KR); Sang-Kuk Woo, Daejeon (KR); Se-Young Kim, Seongnam-si (KR); Jong-Hoon Joo, Chungcheongbuk-do (KR); In-Sub Han, Daejeon (KR); Doo-Won Seo, Daejeon (KR); Min-Soo Suh, Daejeon (KR)

(73) Assignee: KOREA INSTITUTE OF ENERGY RESEARCH, Daejeon (KR)

(21) Appl. No.: 13/959,696

(22) Filed: Aug. 5, 2013

(30) Foreign Application Priority Data
May 10, 2013 (KR) 10-2013-0053348

(51) Int. Cl. H01G 9/21

(52) U.S. Cl. CPC H01G 9/21
USPC 136/205

(57) ABSTRACT

Disclosed is a thermal to electric power generator comprising: a plurality of thermal to electric power generation cells; a case in which the plurality of the thermal to electric power generation cells are placed; a condensing unit which is disposed on an upper portion of the case and collects and condenses a working fluid which has passed through the plurality of the thermal to electric power generation cells; an evaporator which is disposed on a lower portion of the case, converts the working fluid into vapor by transferring heat to the working fluid; a heat exchanger which is placed on a surface other than an upper surface of the outside of the case contacting with the condensing unit; a circulator which connects the condensing unit and the evaporator; and a joiner which joins the evaporator to the plurality of the thermal to electric power generation cells.

### BACKGROUND

1. Field

The present invention relates to a technology capable of maximizing efficiency by uniformly increasing the temperature of an AMTEC system which is driven by external heat and generates electricity and capable of continuously supplying required heat sources.

2. Description of Related Art

Alkali Metal Thermal to Electric Converter (AMTEC) is a thermal to electric power generator capable of generating electrical energy from thermal energy.

When a temperature difference is given to both ends of an ionically conductive Beta-Alumina Solid Electrolyte (BASE), Na charged in the cell is ionized into Na+ due to the vapor pressure difference of Na and is diffused from anode to cathode through the electrolyte, and then is neutralized.

In this case, low voltage and high current are generated. So, when the cells are modularized by being connected in series or in parallel, a large amount of electric power can be generated.

The development of alkali metal thermal to electric converter (AMTEC) technology has started for the purpose of an electric power source for space. The AMTEC has a high power density per unit area and high efficiency, and maintains stability.

The AMTEC uses a variety of heat sources, for example, solar energy, fossil fuel, waste heat, terrestrial heat, nuclear reactor, etc. The AMTEC is comprised of electric power generation cells capable of generating electricity without using a driver such as a turbine, a motor or the like, so that it can directly generate electricity from a portion contacting with the heat. When the AMTEC is formed in the form of a module in series or in parallel, a great amount of electricity of several KW to several hundredths MW can be generated.

The form of waste heat includes flue gas, exhaust air, waste hot water, waste steam and the like. Sensible heat and reaction heat of a product of the production process are also classified into the waste heat. In the collection of the waste heat, there are a variety of forms, standards and materials, etc., of a heat exchanger which is applicable in accordance with the temperature of the waste heat, the condition of flow rate of the waste heat and whether or not the waste heat includes a corrosive material.

A device using the waste heat includes a waste heat collector, an electric heat exchanger, a heat pipe type heat exchanger and the like. In a special case, a separate collection system is considered.

The AMTEC is capable of improving the efficiency by directly generating high-quality electricity from the heat source. Therefore, the AMTEC is now issued as a promising technology replacing the existing power generation technologies, for example, hydro power generation, terminal power generation, nuclear power generation, tidal power generation, wind power generation and so on.

One of the features of the AMTEC power generation technology is to have a structure simpler than that of other thermoelectric conversion devices and to have high energy conversion efficiency.

In particular, compared with a solar thermal power plant, the AMTEC does not require a mechanical driving part like a turbine, etc. Compared with a thermoelectric device, the AMTEC can be applied to a high-capacity, high-efficiency system.

The process of generating electricity in the AMTEC will be specifically described. After the state of Na vapor is changed into a vapor state in a high temperature and high pressure evaporator by a heat source, Na+passes through beta-alumina solid electrolyte (BASE), and free electrons return to a cathode through an electric load from an anode, and then are recombined with ion generated from the surface of a low temperature and low pressure BETA and then is neutralized. Electricity is generated during this process.

The vapor pressure of Na plays the most significant role in a thermal to electric power generator as an energy source or a driving force which generates electricity. Also, free electrons generated during a process in which Na passes through the solid electrolyte due to a concentration difference and temperature difference of a working fluid are collected through electrodes, so that electricity can be generated.

The beta-alumina and Na super-ionic conductor (NASICON) may be used as the solid electrolyte.

However, the NASICON has a problem in its stability of crystal structure when it is exposed to high temperature for a long time.

The beta-alumina includes two kinds of beta‘-alumina and beta”-alumina.

The beta“-alumina has a more improved layer structure so that the conductivity of the Na+ ion is much better. Therefore, the beta”-alumina is now generally used.

A process is repeated in which the neutral Na vapor is condensed by being cooled on the inner surface of a low pressure condenser and is transferred to an evaporator by a capillary wick, and then is changed into a vapor state again. Generally, the temperature of the evaporator is in a range of 900 K to 1,100 K, and the temperature of the condenser in a range of 500 K to 600 K.

It is possible for the efficiency of the thermal to electric power generation of the AMTEC to be up to 40%. The AMTEC has a high power density and a simple structure without a separate driving part.

### PRIOR ART DOCUMENT

In Korean Patent Number 10-1239773, disclosed are a geothermal power generation system using heat exchange between working gas and molten salt and a method of the same, that is to say, disclosed are a geothermal power generation system operated by the heat exchange of the working gas in the ground and a method of the same. More particularly, the geothermal power generation system using heat exchange between working gas and molten salt includes: a heat collector; a plurality of molten salt receivers which receive the molten salt thereinside and are disposed apart from a heat transfer part by a regular interval; a heat exchanger which transfers the heat source of the heat collector to the molten salt of the molten salt receiver; a heat transfer part which is disposed on the ground and receives the heat source of the molten salt through the heat exchange and allows the working gas to flow in and out thereof; a turbine which is connected to the heat transfer part and generates mechanical energy by using the energy of the working gas; and a power generator which is connected to the turbine and generates electrical energy by using the mechanical energy. However, there is still a requirement for a technology capable of maximizing the efficiency by uniformly increasing the temperature of the AMTEC system which generates electricity by being driven by external heat, and of continuously providing required heat source.

### SUMMARY

### Technical Problem

The present invention is to maximize the efficiency by uniformly increasing the temperature of the AMTEC system which generates electricity by being driven by external heat, and to continuously provide required heat source.

According to a conventional method, a working fluid like Na, etc., are heated and evaporated by a heating part placed on one side, and is electrochemically used in the AMTEC and is condensed in a cooling part, so that liquefied Na, etc., circulates in the form of a working fluid.

More specifically, as shown in FIG. 1, a conventional thermal to electric power generator 200 uses a method in which the working fluid is heated by a lower heat source 280, is evaporated in an evaporator 240 and is condensed in a condensing unit 230.

However, in such a method, since only the peripheral portion of the heat source placed on one side is directly affected thereby. Accordingly, a temperature gradient is applied to the AMTEC cell itself, so that electrochemical efficiencies are changed depending on portions. Also, stress occurs due to a thermal gradient, so that the mechanical characteristics of the ceramic and a joiner are deteriorated.

Further, the working fluid like gaseous Na, etc., is condensed in an undesired portion other than the cooling part like a wall, etc., and thus, there may be an adverse effect on the circulation of the working fluid.

### Technical Solution

One aspect of the present invention is a thermal to electric power generator including a plurality of thermal to electric power generation cells including a heat exchanger. The thermal to electric power generator includes: a plurality of thermal to electric power generation cells; a case in which the plurality of the thermal to electric power generation cells are placed; a condensing unit which is disposed on an upper portion of the case and collects and condenses a working fluid which has passed through the plurality of the thermal to electric power generation cells; an evaporator which is disposed on a lower portion of the case, converts the working fluid into vapor by transferring heat to the working fluid and then transfers the working fluid vapor to the plurality of the thermal to electric power generation cells; a heat exchanger which is placed on a surface other than an upper surface of the outside of the case contacting with the condensing unit, and passes a thermal fluid therethrough; a circulator which connects the condensing unit and the evaporator to thereby allow the working fluid to be transferred; a joiner which joins the evaporator to the plurality of the thermal to electric power generation cells; and a heat source which heats the lower portion of the case.

By using such a configuration, recycling can be achieved without a temperature gradient in such a manner that the thermal fluid increases the system temperature through the heat exchanger and circulates. Accordingly, the system can be configured to have a very high efficiency.

### ADVANTAGEOUS EFFECTS

Through the configuration of the present invention, recycling can be achieved without a temperature gradient in such a manner that the thermal fluid increases the system temperature through the heat exchanger and circulates. Accordingly, the system can be configured to have a very high efficiency.

Also, unlike a conventional system, there is little temperature gradient in the system of the present invention. As a result, thermal shock is less generated and the performance of the cells constituting the AMTEC can be maintained constant.

Also, the temperature difference between the system and the cooling part becomes larger, so that the condensation is efficiently carried out only in the cooling part. Accordingly, the working fluid like Na, etc., is able to smoothly circulate.

Through this, the system efficiency can be maximized. Finally, it is possible to easily manufacture the heat exchanger in the form of a module with a compact form which requires only thermal fluid inlet and outlet.

### BRIEF DESCRIPTION OF THE DRAWINGS

FIG. 1 is a diagram showing a principle of operation of a conventional thermal to electric power generator;

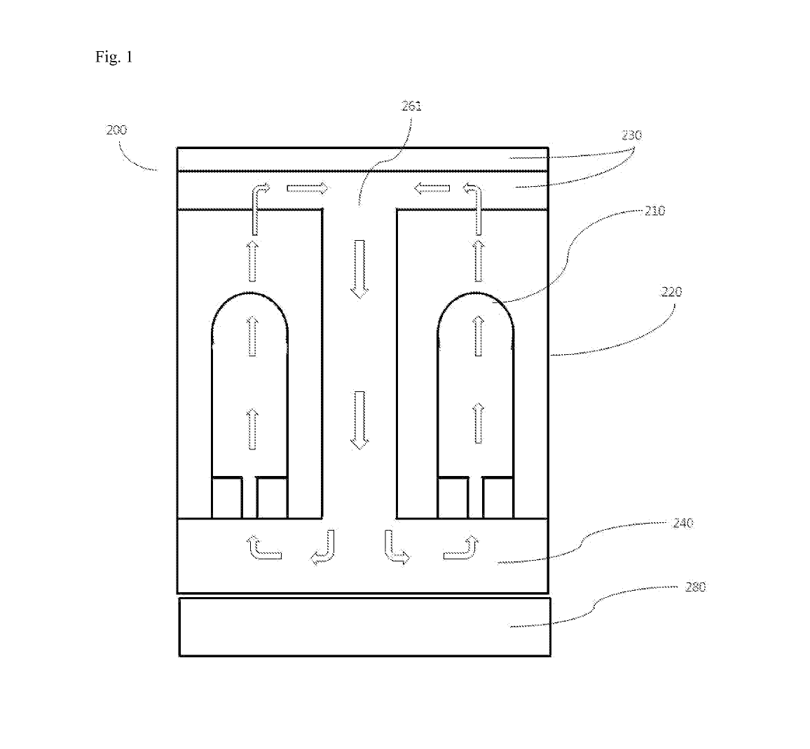

FIG. 2 is a diagram showing a principle of operation of a thermal to electric power generator including a heat exchanger in accordance with the present invention;

FIG. 3 is a diagram showing a principle of operation of a unit thermal to electric power generator in accordance with the present invention; and

FIG. 4 shows a thermal to electric power generation cell according to the present invention.

### DETAILED DESCRIPTION

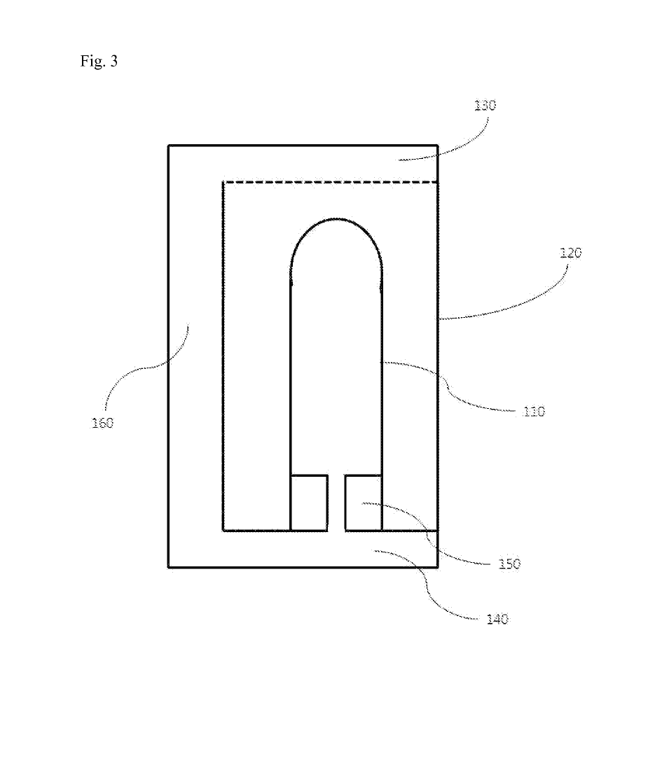

FIG. 3 is a diagram showing a principle of operation of a unit thermal to electric power generator in accordance with the present invention.

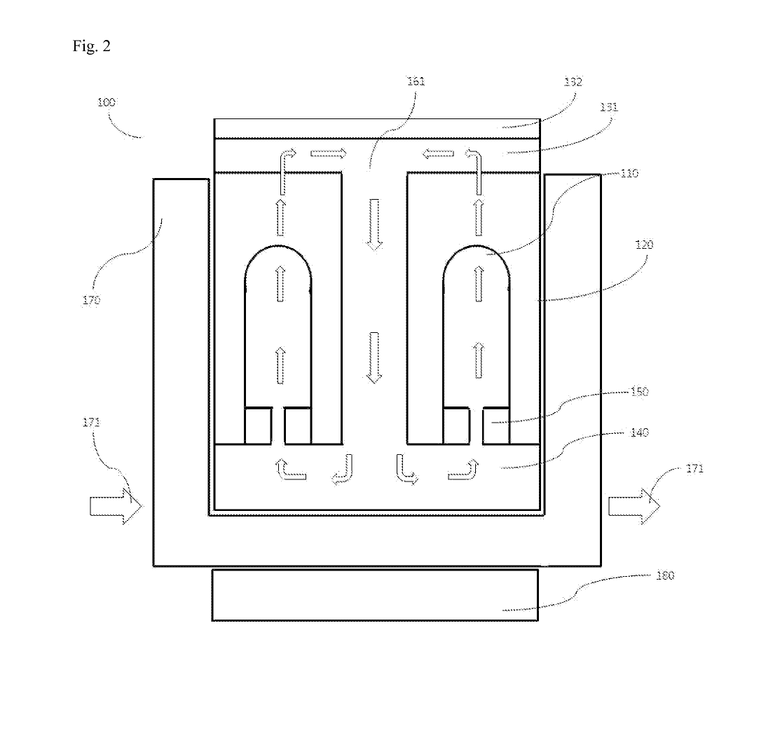

FIG. 2 is a diagram showing a principle of operation of a thermal to electric power generator including a heat exchanger in accordance with the present invention.

The present invention provides a thermal to electric power generator 100 including a plurality of thermal to electric power generation cells 110 including a heat exchanger. The thermal to electric power generator includes: a plurality of thermal to electric power generation cells 110; a case 120 in which the plurality of the thermal to electric power generation cells 110 are placed; a condensing unit 130 which is disposed on an upper portion of the case 120 and collects and condenses a working fluid which has passed through the plurality of the thermal to electric power generation cells 110; an evaporator 140 which is disposed on a lower portion of the case 120, converts the working fluid into vapor by transferring heat to the working fluid and then transfers the working fluid vapor to the plurality of the thermal to electric power generation cells 110; a heat exchanger 170 which is placed on a surface other than an upper surface of the outside of the case contacting with the condensing unit 130, and passes a thermal fluid therethrough; a circulator 160 which connects the condensing unit 130 and the evaporator 140 to thereby allow the working fluid to be transferred; a joiner 150 which joins the evaporator 140 to the plurality of the thermal to electric power generation cells; and a heat source which heats the lower portion of the case 120.

The heat exchanger 170 may uniform a temperature gradient and may include at least one inlet through which a high temperature fluid flows, at least one outlet through which a fluid having a low temperature through heat exchange flows, and a flow part through which the thermal fluid passes. However, the heat exchanger 170 is not limited to this.

The thermal fluid may include at least one of a material having a gaseous form and a material having a liquid form.

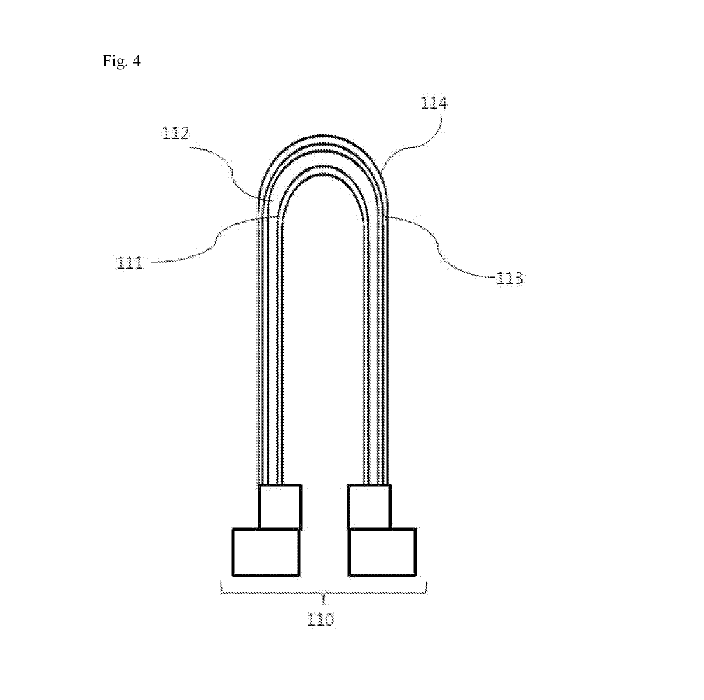

FIG. 4 shows a thermal to electric power generation cell according to the present invention.

The thermal to electric power generation cell 110 may include a tubular metal support 112, a porous internal electrode 111 formed on the inner surface of the tubular metal support 112, a solid electrolyte 113 formed on the outer surface of the tubular metal support 112, and a porous external electrode 114 formed on the surface of the solid electrolyte 113.

The metal support 112 and the internal electrode 111 formed on the inner surface of the metal support 112 may be integrally formed. That is, the internal electrode 111 functioning as the metal support 112 may be formed and used.

The metal support 112 is a porous metal support. It is preferable that the metal support 112 includes at least any one of Mo, Ti, W, Cu, Ni, Fe, and Cr.

The solid electrolyte 113 is a beta-alumina solid electrolyte or a Na super-ionic conductor (NASICON) solid electrolyte. It is preferable that the solid electrolyte 113 is formed in the form of a thin film. It is more preferable that the solid electrolyte 113 is formed in the form of a beta-alumina thin film. However, the solid electrolyte 113 is not limited to this.

It is preferable that the porous electrode includes at least any one of Mo, Ni, Al, PtW, RhW, TiC, TiN, SiN, RuO, Ru₂O, RuW, and NbC.

The thermal to electric power generation cell 110 may further include a power generating unit which is electrically connected to the electrode and the metal support and controls the generated electricity.

The joiner 150 may be formed of an electrical insulating material in such a manner that the electricity generated in the thermal to electric power generation cell 110 flows to the power generating unit. The joiner 150 may also include an insulating alpha-alumina and a metal ring which is placed under the alpha-alumina and improves the joinability with the evaporator 140.

The working fluid may include at least any one of Na, K, and Li. It is the most preferable that the working fluid includes Na, however, there is no limit to this.

The condensing unit 130 may include a capillary wick 131 and a condenser 132. The low temperature-low pressure working fluid passes through the capillary wick 131. The condenser 132 is located on the capillary wick 131.

The circulator 160 may correspond to a capillary circulation wick 161 connected to the condensing unit 130.

By using such a configuration, it is intended to maximize the efficiency by uniformly increasing the temperature of the AMTEC system which generates electricity by being driven by external heat, and to continuously provide required heat source.

By using such a configuration, recycling can be achieved without a temperature gradient in such a manner that the thermal fluid increases the system temperature through the heat exchanger and circulates. Accordingly, the system can be configured to have a very high efficiency.

Also, unlike a conventional system, there is little temperature gradient in the system of the present invention. As a result, thermal shock is less generated and the performance of the cells constituting the AMTEC can be maintained constant.

Also, the temperature difference between the system and the cooling part becomes larger, so that the condensation is efficiently carried out only in the cooling part. Accordingly, the working fluid like Na, etc., is able to smoothly circulate.

Through this, the system efficiency can be maximized. Finally, it is possible to easily manufacture the heat exchanger in the form of a module with a compact form which requires only thermal fluid inlet and outlet.

The present invention has been described with reference to the accompanying drawings. This is just one of various embodiments including the subject matter of the present invention and intends to allow those skilled in the art to easily embody the present invention. It is clear that the present invention is not limited to the above-described embodiments. Therefore, the scope of the present invention should be construed by the following claims. Without departing from the subject matter of the present invention, all the technical spirits within the scope equivalent to the subject matter of the present invention is included in the right scope of the present invention by the modifications, substitutions, changes and the like. Also, it is clear that some of the drawing configuration are intended for more clearly describing the configuration and are more exaggerated or shortened than the actual one.

What is claimed is:

1. A thermal to electric power generator including a plurality of thermal to electric power generation cells including a heat exchanger, the thermal to electric power generator comprising:
a plurality of thermal to electric power generation cells;
a case in which the plurality of the thermal to electric power generation cells are placed;
a condensing unit which is disposed on an upper portion of the case and collects and condenses a working fluid which has passed through the plurality of the thermal to electric power generation cells;
an evaporator which is disposed on a lower portion of the case, converts the working fluid into vapor by transferring heat to the working fluid and then transfers the working fluid vapor to the plurality of the thermal to electric power generation cells;
a heat exchanger which is placed on a surface other than an upper surface of the outside of the case contacting with the condensing unit, and passes a thermal fluid therethrough;
a circulator which connects the condensing unit and the evaporator to thereby allow the working fluid to be transferred;
a joiner which joins the evaporator to the plurality of the thermal to electric power generation cells; and
a heat source which heats the lower portion of the case.

2. The thermal to electric power generator of claim 1, wherein the heat exchanger comprises:
at least one inlet through which a high temperature fluid flows;
at least one outlet through which a fluid having a low temperature through heat exchange flows; and
a flow part through which the thermal fluid passes.

3. The thermal to electric power generator of claim 1, wherein the thermal fluid comprises at least one of a material having a gaseous form and a material having a liquid form.

4. The thermal to electric power generator of claim 1, wherein the heat exchanger uniforms a temperature gradient inside the thermal to electric power generator.

5. The thermal to electric power generator of claim 1, wherein the thermal to electric power generation cell comprises:
a tubular metal support;
a porous internal electrode formed on an inner surface of the tubular metal support;
a solid electrolyte formed on an outer surface of the tubular metal support; and
a porous external electrode formed on a surface of the solid electrolyte.

6. The thermal to electric power generator of claim 5, wherein the metal support is a porous metal support and comprises at least any one of Mo, Ti, W, Cu, Ni, Fe, and Cr.

7. The thermal to electric power generator of claim 5, wherein the solid electrolyte is a beta-alumina solid electrolyte or a Na super-ionic conductor (NASICON) solid electrolyte and is formed in the form of a thin film.

8. The thermal to electric power generator of claim 5, wherein the porous electrode comprises at least any one of Mo, Ni, Al, PtW, RhW, TiC, TiN, SiN, RuO, Ru₂O, RuW, and NbC.

9. The thermal to electric power generator of claim 1, in the thermal to electric power generation cell, further comprising a power generating unit which is electrically connected to the electrode and the metal support and controls the generated electricity.

10. The thermal to electric power generator of claim 9, wherein the joiner is formed of an electrical insulating material in such a manner that the electricity generated in the thermal to electric power generation cell flows to the power generating unit.

11. The thermal to electric power generator of claim 1, wherein the joiner comprises an insulating alpha-alumina and a metal ring which is placed under the alpha-alumina and improves joinability with the evaporator.

12. The thermal to electric power generator of claim 1, wherein the working fluid comprises at least any one of Na, K, and Li.

13. The thermal to electric power generator of claim 1, wherein the condensing unit comprises a capillary wick through which a low temperature-low pressure working fluid passes, and a condenser located on the capillary wick.

14. The thermal to electric power generator of claim 1, wherein the circulator is a capillary circulation wick connected to the condensing unit.
